(19) United States
(12) Patent Application Publication
(10) Pub. No.: US 2013/0191744 A1
(43) Pub. Date: Jul. 25, 2013

(54) SYSTEM AND METHOD FOR GENERATING AND PRESENTING MULTIMEDIA PRESENTATIONS

(71) Applicant: Scott Oscher, New York, NY (US)

(72) Inventor: Scott Oscher, New York, NY (US)

(21) Appl. No.: 13/737,053

(22) Filed: Jan. 9, 2013

Related U.S. Application Data
(60) Provisional application No. 61/584,521, filed on Jan. 9, 2012.

(51) Int. Cl. G06F 3/01

(52) U.S. Cl. CPC G06F 3/01
USPC 715/716

(57) ABSTRACT

A multimedia presentation generation system for generating and presenting multimedia presentations using multimedia assets utilizes an administrative module, a building module, and a presentation module. A visual builder portion of the builder module facilitates the creation of configuration data structures usable by a presentation player mechanism. An administration application interoperates with the visual builder to allow for control of assets, libraries and relationships utilized by the visual builder is defined within the configuration data structures. In one embodiment, the administration application enables an administrator user to add/remove/edit individual users configuration data structures.

### CROSS-REFERENCE TO RELATED APPLICATION

This application claims the benefit of priority to U.S. Provisional Application No. 61/584,521, filed on Jan. 9, 2012, entitled SYSTEM AND METHOD FOR GENERATING AND PRESENTING MULTIMEDIA PRESENTATIONS the entire subject matter of which is incorporated herein by this reference for all purposes.

### BACKGROUND OF THE INVENTION

Existing systems utilized for generating and presenting multimedia presentations are archaic and require a user to spend significant amounts of time to generate high-end multimedia presentations to specific target audiences. Typical systems are difficult to use, require intensive user input and interaction, and do not produce uniform, streamlined presentations.

Accordingly, there is a need for methods and systems for generating and presenting multimedia presentations that provide streamlined creation and delivery of custom interactive presentations, a single source for presentation management and tracking, an intuitive interface that allows a user to preview and detect errors in real-time, while generating high-end rich, multimedia presentations with a simple and easy-to-use interface.

### SUMMARY OF THE INVENTION

According to the disclosure, a multimedia presentation generation system for generating and presenting multimedia presentations using multimedia assets comprises an administrative module, a building module, and a presentation module. A visual builder portion of the builder module facilitates the creation of configuration data structures usable by a presentation player mechanism. An administration application interoperates with the visual builder to allow for control of assets, libraries and relationships utilized by the visual builder is defined within the configuration data structures. In one embodiment, the administration application enables an administrator user to add/remove/edit individual users configuration data structures.

According to one aspect of the disclosure, a system for playback and creation of user customizable presentations comprises: a presentation player mechanism, responsive to a configuration data structure, for displaying the plurality of elements comprising a presentation; a visual builder apparatus comprising a graphic interface for creating configuration data structures usable by the presentation player mechanism for displaying presentations; a storage device, coupled to the visual builder apparatus and the presentation player mechanism, for storing presentation components and data used by the visual builder apparatus; and a storage device, coupled to the visual builder apparatus and the presentation player mechanism, for storing presentation components and data used by the visual builder apparatus; and an administration application coupled to the visual builder apparatus, for controlling assets, libraries and relationships utilized by the visual builder apparatus to create configuration data structures. In one embodiment, configuration data structure or data sheet contains data instructing the presentation player mechanism which presentation component files to load, colors to use, how they look, etc. According to another embodiment, the visual builder apparatus of the system enables users to manage templates they've created, view reports, preview existing presentations, build new presentations, download a presentation as a single executable file, and share a link to their presentation online. According to another embodiment, the visual builder apparatus can prepopulate some or all of the configurable items based on only a few User choices. In another embodiment, the administration application enables an administrator user to add/remove/edit individual users or presentation templates (configuration data structures).

According to another aspect of the disclosure, a method for playback and creation of user customizable presentations comprises: storing in a memory storage device presentation components and data used by the visual builder apparatus to create a presentation; receiving user definable instructions defining relationships among the presentation components and data; displaying with the visual builder apparatus assets, including presentation components and data based on the received user-defined relationships; utilizing the visual builder apparatus to upload selected components and saving of configuration data files; error-checking of presentation components and generation of an authorization key; accessing of all the display components and data by a presentation player mechanism with the authorization key; and; bundling the configuration data structure and presentation player application as a single entity for execution.

### BRIEF DESCRIPTION OF THE DRAWINGS

For a better understanding of the present disclosure, and to show how the same may be carried into effect, reference will now be made, by way of example only, to the accompanying drawings, in which:

FIG. 1 illustrates conceptually the components of a multimedia presentation generation system for generating and presenting multimedia presentations using multimedia assets in accordance with an embodiment of the present disclosure; and

FIG. 2 illustrates conceptually various components of the multimedia presentation generation system with relation to various types of users according to various embodiments of the present disclosure;

FIG. 3 is a conceptual diagram of a network topology in which the disclosed system may be implemented in accordance with various embodiments of the present disclosure; and

FIG. 4 is a conceptual diagram of a computer architecture in accordance with various embodiments of the present disclosure.

### DETAILED DESCRIPTION

Technologies for generating and presenting multimedia presentations are provided herein. By way of the present disclosure, methods and systems of multimedia generation and presentation that provide streamlined creation and delivery of custom interactive presentations, a single source for presentation management and tracking, an intuitive interface that allows a user to preview and detect errors in real-time, while generating high-end rich, multimedia presentations with a simple and easy-to-use interface are disclosed.

The present disclosure will be more completely understood through the following description, which should be read in conjunction with the attached drawings and appendix. In this description, like numbers refer to similar elements within various embodiments of the present disclosure. Within this description, the claimed disclosure will be explained with respect to embodiments. The skilled artisan will readily appreciate that the methods and systems described herein are merely exemplary and that variations can be made without departing from the spirit and scope of the disclosure.

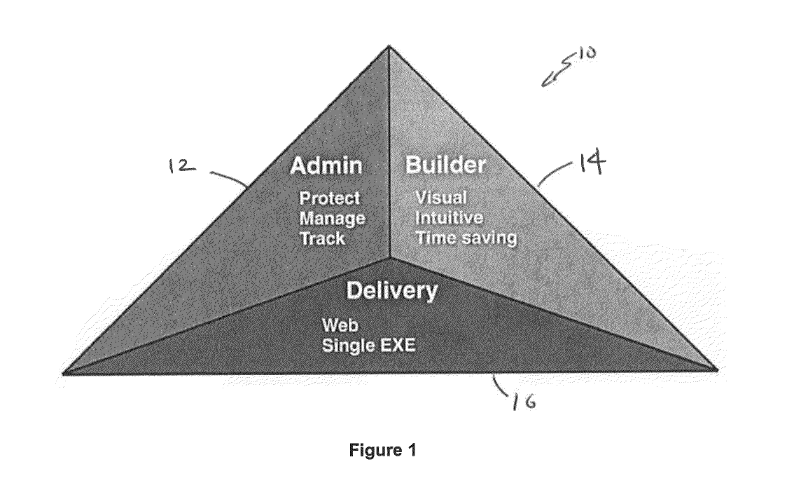

Referring now to the figures, FIG. 1 illustrates conceptually a multimedia presentation generation system 10 for generating and presenting multimedia presentations using multimedia assets in accordance with embodiments of the present disclosure. A multimedia presentation generation system 10 comprises an administrative module 12, a building module 14, and a presentation module 16, details of each being provided below.

The administrative module 12 is configured to provide a single, protected source for all Library assets. As a result, the administrative module is configured to upload, tag and manage assets and manage re-usable presentation templates. Furthermore, the administrative module can be used for building desktop and web based presentations as well as manage and track presentation creation.

The building module 14 is configured to allow users to quickly and easily build, compile, save and download or email links to web-based presentations. The building module may interact with the administrative module to generate multimedia presentations, which can then be delivered to others for viewing using a delivery or presentation module. The builder module is further configured to make presentation creation simple and intuitive using a graphical interface for building presentations. In some embodiments, a user can preview each element before building or preview the entire presentation before building or compiling the presentation. In some embodiments, the building module may be configured to automatically build presentations based on templates, verticals and target companies. In various embodiments, the building module can perform error checking prior to building. Furthermore, the building module provides a single point of access for presentation creation and can protect assets from modification, damage, and even accidental deletion.

The presentation module 16 may be configured to allow viewers to view generated presentations in a streamlined fashion. In various embodiments, the presentation module may be a web application or a standalone product. By way of the present disclosure, presentations generated by embodiments of the present disclosure can be delivered to users as a single executable file or via email link for web playback. Furthermore, the presentation module may allow users to share presentations with other users by emailing links to web based presentations. In addition, the presentation module may ensure that viewers only see presentations to which they have authorized access.

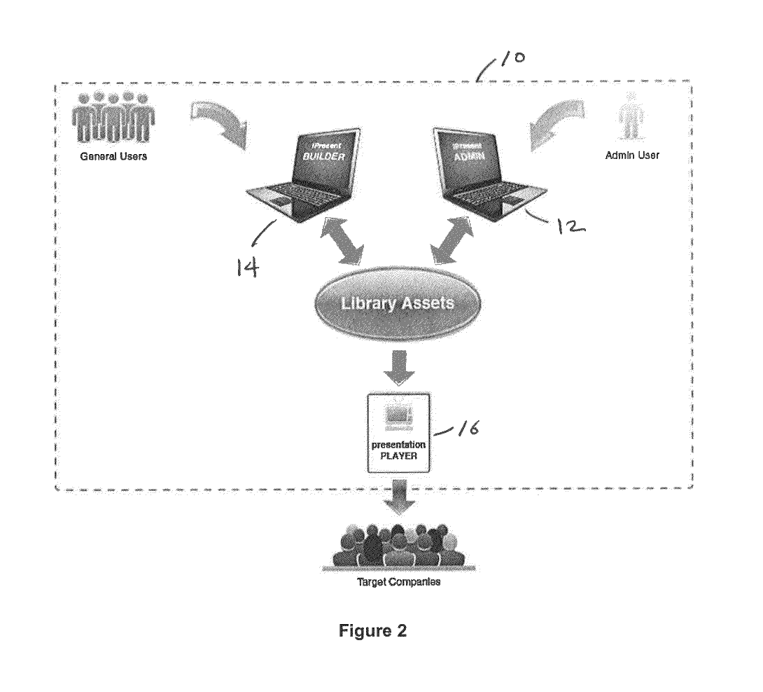

Additional details of the administrative module, the building module and the presentation module are provided with respect to FIG. 2 which illustrates various components of the multimedia presentation generation system with relation to various types of users according to various embodiments of the present disclosure. In various embodiments, the multimedia presentation generation system comprises the presentation module 16, the building module 14, and the administrative module 12.

The Administrative Module

The administrative module 12 is the repository for all items and data used by the building module. The administrative module allows an admin user to control all the assets, libraries and some of the relationships that the building module uses to create templates. The administrative module also controls Users and their rights, including but not limited to, modifying properties and rights of users, for instance, adding and/or removing users, or editing access rights of one or more users. Furthermore, the administrative module can add/edit/delete any presentation template.

The Building Module

The building module 14 is the graphic interface for creating configuration templates (config) and him and him and him and him and him and that the presentation module uses to display presentations. Users can manage templates they've created, view reports, preview existing presentations, build new presentations, download a presentation as a single executable file, and share a link to their presentation online. Using the multimedia presentation generation system, the building module will prepopulate most of the configurable items based on only a few User choices.

The Presentation Module

The presentation module 16 or player is essentially a container used for displaying all the elements in a presentation. It reads a config or data sheet which informs the presentation module how to present the presentation to a viewer. This includes providing the presentation module various information, including which files to load, which colors, fonts, and sizes to use, as well as other information related to presenting the presentation to viewers. Rather than a model of a Player for every presentation, a single player is configured to be able to present all presentations generated by the multimedia presentation generation system.

In various embodiments of the present disclosure, the administrative module, the building module and the presentation module are configured to operate together as the multimedia presentation generation system. In some aspects, the administrative module uploads and maintains all the demos (chapters/applications) movies, audio files. The administrative module defines relationships by making certain selections when uploading items.

The building module displays assets based on relationships defined in the administrative module. The building module allows for uploading of certain assets and saving of configuration data files, and can also check for errors, thereby prevents faulty final presentation templates from being created.

The presentation module may either be a web-based application, in which case, the presentation module accesses all the data from a key generated by the building module. This allows for a single player and a single source of all presentation assets. In other embodiments, the presentation module may be a part of a downloaded executable file that is packaged by the building module. In such embodiments, the presentation module includes all components necessary to play that particular presentation.

In various aspects of the present disclosure, The multimedia presentation generation system can also include a license server module that may be hosted by a third-party server, which can generate a license key to control the dissemination of the presentations, while also provide mechanisms through which the presentations can only be viewed by authorized viewers. In various embodiments, the license key can define a maximum number of viewers, as well as start and stop dates within which the presentation can be viewed. Additional restrictions can be implemented using the license key.

The following details the procedural flow by which a user may create a presentation utilizing the builder module and its associated user-interface:
1. User logs on and is presented with Home tab
   a. can download an existing presentation
   b. can use an existing presentation as a base for a new presentation (edit)
   c. can “Share” a link to an existing presentation they have created
   d. can view reports on presentations they have created
   e. can make their web presentations active/inactive
   f. can delete their existing presentations
   g. Filter displayed presentations by
      i. Vertical
      ii. Target Company
      iii. Author
   h. User can start from scratch by clicking “Start”
      i. Requires a Vertical and Target Company selection
2. “Start” or “Edit” brings users to the Builder tab where they are presented with a list of “Applications” (which is really a list of demos/chapters) available for this particular vertical, a version of the config and the ability to error check, preview, save and build the presentation.
   a. The user can also change vertical and target company
   b. The “Application” list allows users to quickly select up to 5 demos to have in their presentation
   c. The config automatically display/fill in selections based on vertical and target company and/or previously saved data
   d. If there are errors or missing data the user can now go to the appropriate tab and fill in/customize as desired/required
3. The Player Tab allows the user to define the graphic elements for the Player
   a. Most of these options are automatically selected based on Vertical and
   Target Company
   b. There can be multiple image choices
   c. The user can fine tune positioning of images using the steppers or dragging from within the zoom window
   d. User can choose Primary and Secondary colors for the presentation which would then be visible in the preview window
   e. Users can upload image files for the different elements
      i. These files may become available for all users
4. The Select Demos tab allows the user to define which chapters are in the presentation. There may be a max of 5 per presentation.
   a. Demos are filtered by Vertical
   b. Once a user selects a Demo, if there is an audio swap for that demo the appropriate dropdown appears with the target company specific audio files to choose from.
      i. The user can preview the audio file
   c. The user can change Button Titles
      i. Defaults are set in the admin
   d. The User can change Headings and bullets for each demo
      i. Defaults are set in the admin
   e. The user can preview any Demo
5. The Introduction tab may rarely be accessed—most users will let this run on defaults
   a. There could be more than 1 video introduction
   b. Users can choose which file or turn it off altogether
   c. Users can preview the introduction
6. The Advanced Color Tab is also something that would be rarely accessed but provides users with the ability to fine tune the presentation colors.
   a. The preview window shows the Primary and Secondary color choices from the player tab, as well
   b. eyedropper to pick colors from the logos
   c. Users can easily revert back to the defaults
7. Once all of the choices have been made the user returns to the Builder Tab and can proceed to Save, Check, Preview or Build their presentation.
   a. Users can define a unique name for their presentation
   b. Users then choose whether to download an exe or a web version
      i. Exe will collect all the assets necessary for the presentation, compile it into a single exe and then the user can download
      ii. Web will generate a unique URL that the player can decode to provide access to the right presentation
   c. The server may not store actual presentations—only templates

The following details the various functionality associated with the user-interface of the builder module:

### Home Tab

Shows a table of available presentations
Columns are sortable
Delete
   Presentation/Template creators and Admin can delete their templates through the Builder Home Page
Preview
   Anyone can preview
Share
   Creators and Admin can send emails with links to the presentation
Live
   Creators and Admin can turn on/off the web presentation
      Basically it means the emailed links are active/inactive
Reports
   Creators and Admin can view reports for individual presentations
Only completed presentations (no errors) can be directly downloaded
If you are the author, clicking on edit will allow you to edit your presentation—
   all other users this becomes a base for a new presentation
   clicking on edit takes users to the Builder screen
Mousing over the presentation name displays the description—if any exists
Template Filters allow users to sort available presentations by Vertical, Target Company or Author

### Builder Tab

Right Panel is the config
   As the user makes choices this gets filled in
   If there are errors or required items are missing notifications will display here
Player
Target Logo
Build Menu
   Vertical, Target Company dropdowns to allow easy updating
      This allows users to easily change vertical and company
      Clicking on update will update the options throughout the Builder
   Applications List
      Allows users to select up to 5 demos to use in presentation
         Can choose either male or female version
         Automatically selects appropriate audio file
   Vertical, Target Company dropdowns to allow easy updating
   This allows users to easily change vertical and company
   Applications List
      Allows users to select up to 5 demos to use in presentation
         Can choose either male or female version
         Automatically selects appropriate audio file
   Clicking on check will have the application check for errors—which will be displayed in the config area
   Clicking on Preview will first check for errors. If there are no errors it will launch a preview of the presentation—
   Clicking on Finish Your Presentation will first check for errors. If there are errors they must be corrected prior to building the presentation. Then the user will be asked to name the presentation and provide a description (description not required).
      The template gets saved
      The user can choose to download a compiled EXE or publish it to the web
   Clicking on Save Your Template allows the user to name and save their progress for later use—
      When saving, the following information is saved with the template:
         Username
         Target Company
         Market Segment
         Description
         Date

### Player Tab

All dropdowns are populated based on Vertical and Target Company values. Where possible anything required is preselected, as well as non-required items that have data. There will be many cases where dropdowns will have multiple options—for example Watermark will have a default watermark image and possibly one or more vertical specific images. Vertical specific would take precedence over default and be automatically selected:

### 1. Target Logo, Large Target Logo, Target Slogan

a. Dropdown menu limited by Vertical and Company Name
b. Automatically filled in whenever possible
c. On selection of image
   i. logo appears exactly where it would be in the Player in Zoom Preview window
   ii. logo appears in Preview window 2
d. clicking on the magnifying glass icon puts the logo in the Zoom Preview Window for manual adjustment (user can drag the image)
e. 3 ways to adjust position
   i. Fields to manually enter X & Y position
   ii. Numeric stepper to change position by pixel
   iii. Allow the user to manually “grab” and move the logo in the zoom preview window
f. Provide scale field and numeric steppers
g. All three options automatically update when any is used.
h. All preview windows update as well
i. Users can upload their own images

### 2. Watermark Image, Bottom Right Image

a. Dropdown menu limited by Vertical
   i. If no files exist for that Vertical, default is displayed.
   ii. Default is always an option
b. On selection of image, preview appears in Zoom window
c. 3 ways to adjust position
   i. Fields to manually enter X & Y position
   ii. Up and Down counters to change position by pixel
   iii. Allow the user to manually “grab” and move the logo in the preview window
d. scale field and counters
e. Users can upload their own images

### 3. Primary Color, Secondary Color

a. Text field for entering the hex color
b. Color picker button to open color picker with eyedropper
   i. User can be pick colors from logos
c. Colors update in the preview windows

### Select Demos Tab

### 1. Number of Demos

a. Text Field with numeric stepper
b. Making this choice defines the number of Demo forms that appear

### 2. Demos (Application)

a. File
   i. Dropdown menu limited by Vertical
   ii. Tooltip showing Direction, Gender and Length
b. Button Text L1, L2
   i. Automatically filled in on file selection
c. Beginning Audio
   i. Dropdown menu
      1. Automatically filled in based on Target Company, Sample Direction, Sample Gender and whether or not it uses an Audio Swap
   ii. Filtered by company
d. Ending Audio
   i. Dropdown menu
      1. Automatically filled in based on Target Company, Sample Direction, Sample Gender and whether or not it uses an Audio Swap
   ii. Filtered by company

### 3. Preview

i. Launches a new window showing a preview of the Application

### Introduction Tab

### 1. Use Intro

a. True/False
b. Default=True

### 2. File

a. Dropdown with files based on Vertical
b. If no intro exists within a Vertical then Default Intro is default value
c. Icon to launch preview

### Advanced Color

1. All advanced color items
a. Text field for entering the hex color
b. Color picker button to open color picker with eyedropper
   i. User should be able to pick colors from logos
c. Colors should update in the preview window
   i. Preview window should be same from Player Tab
d. Defaults should already be entered

System Implementation

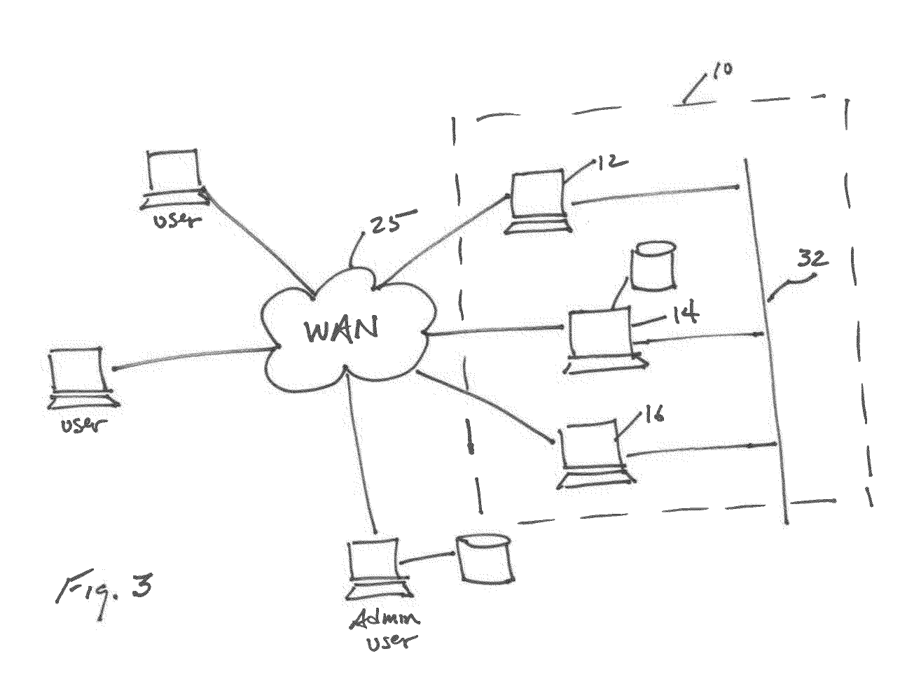

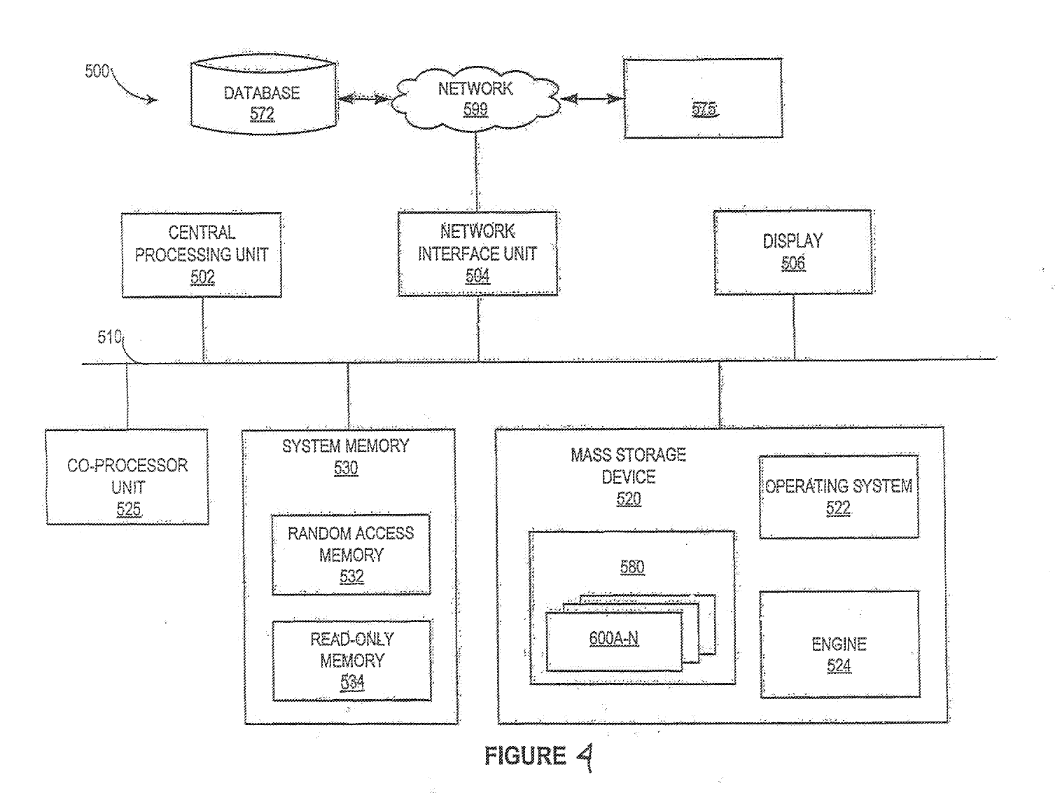

FIG. 3 illustrates a network topology in which the components of the system 10 illustrated in FIG. 2 and may be organized. Note that any of the systems illustrated in FIG. 2 may be interoperably connected either through a wide area network (WAN) 25 or local area network (LAN) 32 or both, or any hybrid combination thereof using known network components, protocols and topologies. The computer architecture described with reference to FIG. 4 herein may be to implement any of the processing platforms illustrated in FIG. 3. In FIG. 3, each of the administrative module 12, building module 14 and presentation module 16 made execute on remotely located systems interoperable he coupled over network 25, as illustrated. Alternatively, one or more of the modules may execute on any one of the processing platforms illustrated in FIG. 3. Similarly, users creating presentations as well as an administrative user may be located remotely from the actual modules 12, 14 or 16 and connected operably thereto through network 25, or connected directly into the computing platform executing the respective module.

Referring to FIG. 4, a computer system 500 comprises a central processing unit 502 (CPU), a system memory 530, including one or both of a random access memory 532 (RAM) and a read-only memory 534 (ROM), and a system bus 510 that couples the system memory 530 to the CPU 502. An input/output system containing the basic routines that help to transfer information between elements within the computer architecture 500, such as during startup, can be stored in the ROM 534. The computer architecture 500 may further include a mass storage device 520 for storing an operating system 522, software, data, and program modules 12, 14 and 16, executable by engine 524.

The mass storage device 520 may be connected to the CPU 502 through a mass storage controller (not illustrated) connected to the bus 510. The mass storage device 520 and its associated computer-readable media can provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media that can be accessed by the computer architecture 500.

By way of example, and not limitation, computer-readable media may include volatile and non-volatile, removable and non-removable media implemented in any method or technology for the non-transitory storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer architecture 500.

According to various embodiments, the computer architecture 500 may operate in a networked environment using logical connections to remote physical or virtual entities through a network such as the network 599, which may be similar to network 25 of FIG. 3. The computer architecture 500 may connect to the network 25 through a network interface unit 504 connected to the bus 510. It will be appreciated that the network interface unit 504 may also be utilized to connect to other types of networks and remote computer systems. The computer architecture 500 may also include an input/output controller for receiving and processing input from a number of other devices, including a keyboard, mouse, or electronic stylus (not illustrated). Similarly, an input/output controller may provide output to a video display 506, a printer, or other type of output device. A graphics processor unit 525 may also be connected to the bus 510.

As mentioned briefly above, a number of program modules and data files may be stored in the mass storage device 520 and RAM 532 of the computer architecture 500, including an operating system 522 suitable for controlling the operation of a networked desktop, laptop, server computer, or other computing environment. The mass storage device 520, ROM 534, and RAM 532 may also store one or more program modules. In particular, the mass storage device 520, the ROM 534, and the RAM 532 may store the presentation engine 524 for execution by the CPU 502. The engine 524 can execute software components for implementing any of modules 12, 14 or 16 discussed in detail with respect to FIG. 2. The mass storage device 520, the ROM 534, and the RAM 532 may also store other types of program modules.

Software modules, such as modules 12, 14 or 16 may be associated with the system memory 530, the mass storage device 520, or otherwise. According to embodiments, the engine 524 may be located at any accessible node on the network 599 and accessed by any computer within the network 599.

The software modules 12, 14 or 16 may include software instructions that, when loaded into the CPU 502 and executed, transform a general-purpose computing system into a special-purpose computing system customized to facilitate all, or part of, the techniques disclosed herein. As detailed throughout this description, the program modules may provide various tools or techniques by which the computer architecture 500 may participate within the overall systems or operating environments using the components, logic flows, and/or data structures discussed herein.

In the illustrative embodiment, the various presentation templates 600A-N, including one or more configuration data structures, may be stored directly on system 500 as part of library assets 580, or, alternatively, remotely in database 572 accessible over a network 599, as illustrated in FIG. 4. Users creating presentations as well as an administrative user may be located on system 575 remotely from any of modules 12, 14 or 16 and connected operably thereto through network 599, or connected directly into the computing platform executing the respective module.

The CPU 502 may be constructed from any number of transistors or other circuit elements, which may individually or collectively assume any number of states. More specifically, the CPU 502 may operate as a state machine or finite-state machine. Such a machine may be transformed to a second machine, or specific machine by loading executable instructions contained within the program modules. These computer-executable instructions may transform the CPU 502 by specifying how the CPU 502 transitions between states, thereby transforming the transistors or other circuit elements constituting the CPU 502 from a first machine to a second machine, wherein the second machine may be specifically configured to manage the generation of indices. The states of either machine may also be transformed by receiving input from one or more user input devices associated with the input/output controller, the network interface unit 504, other peripherals, other interfaces, or one or more users or other actors. Either machine may also transform states, or various physical characteristics of various output devices such as printers, speakers, video displays, or otherwise.

Encoding of executable computer program code modules may also transform the physical structure of the storage media. The specific transformation of physical structure may depend on various factors, in different implementations of this description. Examples of such factors may include, but are not limited to: the technology used to implement the storage media, whether the storage media are characterized as primary or secondary storage, and the like. For example, if the storage media are implemented as semiconductor-based memory, the program modules may transform the physical state of the system memory 530 when the software is encoded therein. For example, the software may transform the state of transistors, capacitors, or other discrete circuit elements constituting the system memory 530.

As another example, the storage media may be implemented using magnetic or optical technology. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. It should be appreciated that various other transformations of physical media are possible without departing from the scope and spirit of the present description.

While the foregoing has described what is considered to be the best mode and, where appropriate, other modes of performing the disclosure, the disclosure should not be limited to specific apparatus configurations or method steps disclosed in this description of the preferred embodiment. Those skilled in the art will also recognize that the disclosure has a broad range of applications, and that the embodiments admit of a wide range of modifications without departing from the inventive concepts.

What is claimed is:

1. A system for playback and creation of user customizable presentations comprises:
a presentation player mechanism, responsive to a configuration data structure, for displaying the plurality of elements comprising a presentation;
a visual builder apparatus comprising a graphic interface for creating configuration data structures usable by the presentation player mechanism for displaying presentations;
a storage device, coupled to the visual builder apparatus and the presentation player mechanism, for storing presentation components and data used by the visual builder apparatus; and
an administration application coupled to the visual builder apparatus, for controlling assets, libraries and relationships utilized by the visual builder apparatus to create configuration data structures.

2. A method for playback and creation of user customizable presentations comprises:
storing in a memory storage device presentation components and data used by the visual builder apparatus to create a presentation;
receiving user definable instructions defining relationships among the presentation components and data;
displaying with the visual builder apparatus assets, including presentation components and data based on the received user-defined relationships;
utilizing the visual builder apparatus to upload selected components and saving of configuration data files;
error-checking of presentation components and generation of an authorization key;
accessing of all the display components and data by a presentation player mechanism with the authorization key; and
bundling the configuration data structure and presentation player application as a single entity for execution.
